(19) United States
(12) Patent Application Publication
(10) Pub. No.: US 2025/0369832 A1
(43) Pub. Date: Dec. 4, 2025

(54) THERMAL CHAMBER FOR ELECTRIC DRIVE UNIT TESTING

(71) Applicant: Canoo Technologies Inc., Torrance, CA (US)

(72) Inventors: Chad Rumgay, Torrance, CA (US); Leandro Peres de Oliveira, Redondo Beach, CA (US); Matthew Jackson Moore, Oklahoma City, OK (US); Kartik Gopalakrishnan, Torrance, CA (US); Cleber Celli, Torrance, CA (US); Siddhant Shah, Torrance, CA (US); Leonardo Bara Menezes, Redondo Beach, CA (US)

(21) Appl. No.: 18/679,337

(22) Filed: May 30, 2024

(51) Int. Cl. G01M 99/00

(52) U.S. Cl. CPC G01M 99/002

(57) ABSTRACT

A thermal chamber is configured to be assembled around a drive unit assembly to be thermally tested, with load units, torque meters, a chiller, and a hot air blower outside the thermal chamber. Four side panels and a top cover form, together with the surface supporting the drive unit assembly to be tested, the thermal chamber. The side panels and top cover are secured by latches, with cut-outs and inserts allowing thermal chamber to be assembled around the drive unit assembly to be tested while already connected to the load units.

### TECHNICAL FIELD

This disclosure relates generally to thermal testing. More specifically, this disclosure relates to a system and method for cost-and space-efficient electric drive unit thermal testing.

### BACKGROUND

The drive unit assembly for electric vehicles (EVs) is generally considered to include the (electric) motor (which comprises a stator and a rotor), the gearbox, and the differential assembly. During design validation, testing the drive unit assembly under extreme conditions (e.g., −40 degrees Celsius (° C.) up to 85° C.) is desirable. At a component level, drive unit testing at extreme temperatures is especially important to avoid customer and in-field issues. Thermal testing of drive units helps in validating the system and design requirements of the drive unit, and also facilitates discovery of potential failure modes and/or design flaws resulting in issues such as oil leaks or coolant leaks, characterization of drive unit de-rated performance, and determination of efficiency losses due to extreme temperatures.

Currently, drive unit thermal tests may be performed under contract at test facilities that use complex systems for cooling or heating test chambers, where those test chambers encompass the entire dynamometer as well as the drive unit. The use of a walk-in thermal chamber, for example, is expensive and, although often used for vehicle-level testing, is inefficient for component-level testing, and results in high testing costs. On the other hand, some testing facilities connect a thermal chamber to a foam box encompassing the unit under test. The entire thermal chamber initially heats or cools the testing area, then temperature is transferred to the foam box through the hoses connected in the chamber. This solution is highly inefficient, consumes a lot of energy, and does not consistently provide accurate results.

### SUMMARY

The present disclosure provides a system and method for thermal testing of a drive unit assembly design. A thermal chamber is configured to be assembled around a drive unit assembly to be thermally tested, with load units, torque meters, a chiller, and a hot air blower outside the thermal chamber. A radiator and chiller system are employed to heat or cool the drive unit assembly inside the thermal chamber for testing. Four side panels and a top cover form, together with the surface supporting the drive unit assembly to be tested, the thermal chamber. The side panels and top cover are secured by latches, with cut-outs and inserts allowing thermal chamber to be assembled around the drive unit assembly to be tested while already connected to the load units.

In a first embodiment, a structure for thermal testing of a drive unit assembly includes four side panels and a top cover configured to be assembled around the drive unit assembly. The four side panels and the top cover form, with a surface underlying the drive unit assembly, a thermal chamber enclosing the drive unit assembly. An opening through at least one of the four side panels is positioned to allow mechanical connection therethrough of the drive unit assembly to at least one load unit outside the thermal chamber. A plurality of latches secure contacting pairs of the four side panels to each other and secure the top cover to the four side panels. Pass throughs within one or more of the four side panels receive coolant hoses connecting thermal devices within the thermal chamber to a chiller outside the thermal chamber.

In a second embodiment, a method for thermal testing of a drive unit assembly includes assembling four side panels and a top cover around the drive unit assembly. The four side panels and the top cover form, with a surface underlying the drive unit assembly, a thermal chamber enclosing the drive unit assembly. The method also includes enclosing an opening through at least one of the four side panels for a mechanical connection between the drive unit assembly and at least one load unit outside the thermal chamber. The method further includes securing contacting pairs of the four side panels to each other and to secure the top cover to the four side panels with a plurality of latches. The method still further includes connecting thermal devices within the thermal chamber to a chiller outside the thermal chamber using coolant hoses and pass throughs within one or more of the four side panels.

In some embodiments, a radiator and cooling fans may be mounted within the thermal chamber, oriented to blow cool air on the drive unit assembly, and the radiator may be connected to the chiller with the coolant hoses.

In some embodiments, the opening may include a first opening through a first one of the four side panels, positioned to allow mechanical connection therethrough of the drive unit assembly to a first load unit outside the thermal chamber, and a second opening through a second one of the four side panels, positioned to allow mechanical connection therethrough of the drive unit assembly to a second load unit outside the thermal chamber.

In some embodiments, at least one of the four side panels may include a cut-out and an insert collectively forming the opening.

In some embodiments, a hot air blower may be supported with a mount on one of the four side panels or the top cover, with an outlet for the hot air blower inserted in an opening through the top cover.

In some embodiments, a mount for a torque meter may be secured to at least one of the four side panels.

In some embodiments, each the four side panels may comprise insulation material and metal on each side of the insulation material.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 is a diagrammatic illustration of an example thermal testing system according to embodiments of the present disclosure;

FIG. 2 depicts a perspective view of a thermal enclosure for use in the thermal testing system of FIG. 1; and

FIGS. 3A and 3B are pictorial illustrations of portions of the example thermal testing system of FIG. 1.

### DETAILED DESCRIPTION

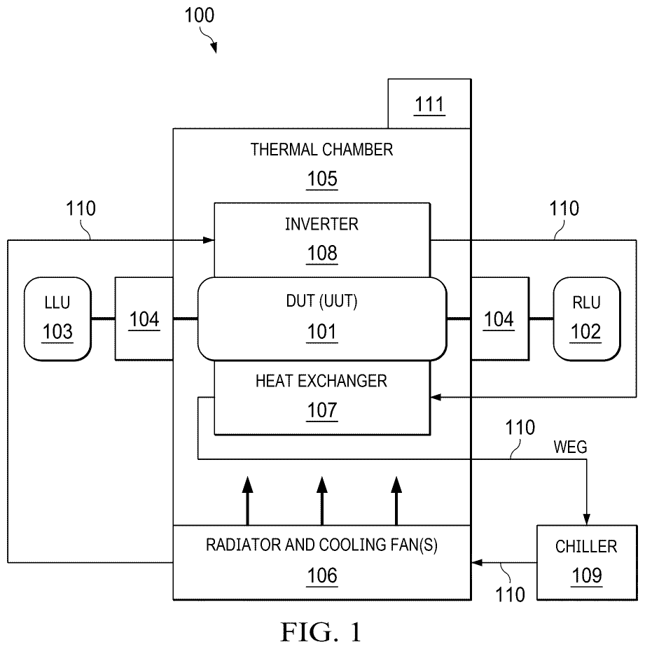

FIGS. 1 through 3B, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

FIG. 1 is a diagrammatic illustration of an example thermal testing system according to embodiments of the present disclosure. The embodiment of the thermal testing system 100 illustrated in FIG. 1 is for illustration and explanation only. FIG. 1 does not limit the scope of this disclosure to any particular implementation of a thermal testing environment.

The thermal testing system 100 is utilized for drive unit system durability and thermal endurance tests-for example, high temperature operation (HTO) and high temperature operation endurance (HTOE), powered thermal cycling endurance (PTCE), low temperature flow (LTF), and cold start tests. The thermal chamber employed is capable of sustaining temperatures of −25° C. to 85° C. The thermal testing system 100 may be assembled in a relatively small space, and disassembled for storage when not in use.

The testing configuration is a back-to-back layout of the device under test (DUT) 101 (a/k/a unit under test (UUT)), a right load unit (RLU) 102, and a left load unit (LLU) 103, with torque meters 104 connected between the DUT 101 and each of RLU 102 and LLU 103. The DUT 101 is a drive unit assembly design mechanically connected via the torque meters 104 to the RLU 102 and the LLU 103. The RLU 102 and the LLU 103 may be motors with locked differentials. The torque meters 104 are capable of reading peak output torque of the DUT 101.

In the example illustrated in FIG. 1, the thermal testing system 100 includes a thermal chamber 105 installed over the DUT 101 to achieve the desired operating temperatures-but not over the torque meters 104, the RLU 102, or the LLU 103. The torque meters 104, the RLU 102, and the LLU 103 remain external to the thermal chamber 105.

Inside the thermal chamber 105 is mounted a radiator and cooling fans 106. Together with a heat exchanger 107 and an inverter 108, the radiator and cooling fans 106 forms coolant flow series circuit with external chiller 109 via coolant hoses 110. A water ethylene glycol (WEG) coolant mixture may be employed. The external chiller 109 is setup to cool the interior of the thermal chamber 105, including the DUT 101 therein. The radiator and cooling fans 106 are installed so that cool air blows towards the DUT 101. Like the chiller 109, a heat blower 111 is disposed outside the thermal chamber 101. Coolant circulation hoses 110 are partially inside and partially outside.

The thermal chamber 101 is configured to be easily assembled over the DUT 101 for testing of a drive unit assembly design, and then disassembled for compact storage when not in use. Coolant is circulated through radiator and cooling fan(s) 103, heat exchanger 104, inverter 105, and chiller 109 by coolant hoses 110.

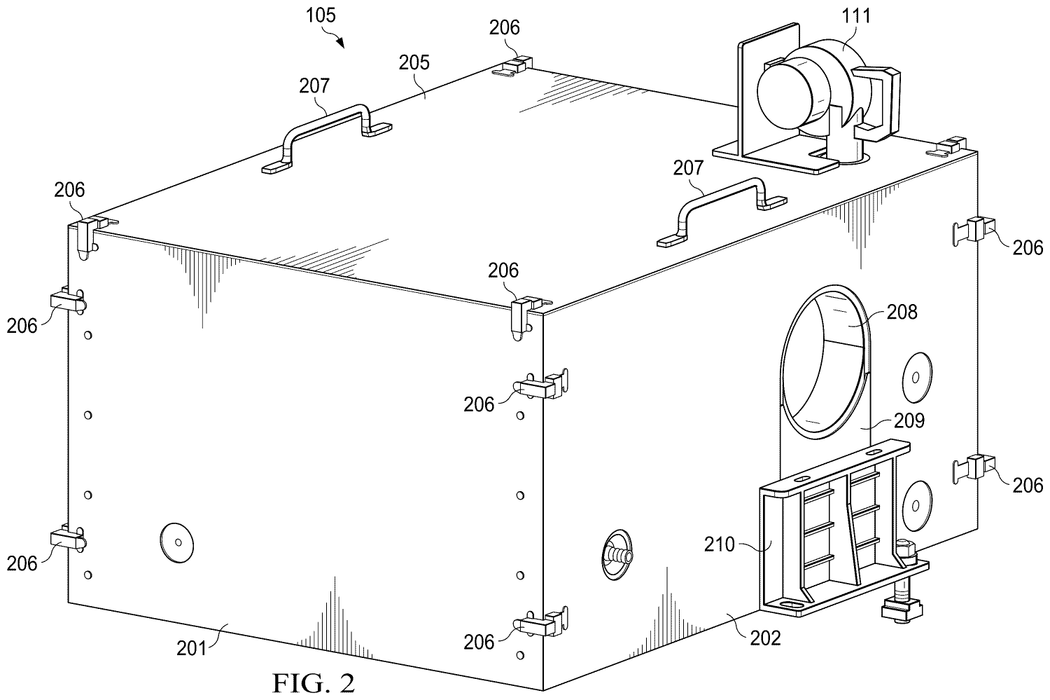

FIG. 2 depicts a perspective view of a thermal enclosure 105 for use in the thermal testing system 100 of FIG. 1. Thermal enclosure 105 is formed by a front cover 201, a left cover (not visible in FIG. 2), a right cover 202, a rear cover (also not visible in FIG. 2), and a top cover 205. The front cover 201, the left cover, the right cover 203, and the rear cover each may be formed of insulation material (e.g., 3 inch thick melamine foam, R=12) with aluminum sheet on each side (e.g., 0.09 inch thick grade 6061 on an outer side, 0.032 inch thick grade 6061 on an inner side), with both ends of two opposing outer sides folded over to form hollow corner posts. The top cover 205 may be formed of a single aluminum sheet on which is centered a rectangle of insulation material sized to sealingly fit into the upper opening of the front cover 201, left cover, right cover 202, and rear cover, when assembled.

The front cover 201, the left cover, the right cover 202, the rear cover, and the top cover 205 may be secured to each other by latch-style toggle clamps 206. Handles 207 may be provided on the top cover 205 for case in lifting the top cover 205 onto or off of the remainder of the enclosure for the thermal chamber 105. The left cover and the right cover 202 each have a cut-out 208 fitting around drive unit axles, with minimum surrounding air gap. In the example of FIG. 2, each cut-out 208 is U-shaped, and receives an insert 209 filling a portion of the respective cut-out 208 that is not necessary to allow the drive unit axle to pass through the respective left or right cover. The U-shaped cut-outs 208 and corresponding inserts 209 allow the thermal chamber 105 to be assembled around the drive unit assembly 101 that is to be tested, while already connected to the RLU 102 and the LLU 103.

Proper air sealing is necessary of all seams between the front cover 201, the left cover, the right cover 202, the rear cover, and the top cover 205, between the thermal enclosure 105 and the underlying floor, and around rotating components and pass-throughs for coolant hoses 110 or power cables (e.g., for the radiator and cooling fan(s) 103) to ensure optimum thermal efficiency during operation. For example, seams between the cut-outs 208 and the inserts 209 may be covered with thermal tape when the thermal testing system 100 is in use.

The left cover and the right cover 202 may each include a mounting bracket 210 for the torque meter 104 to be employed on that side of the thermal chamber 105. The top cover 205 includes a mount configured to support the heat blower 111, which is oriented to blow hot air into the thermal enclosure 105 from an outlet of the hot air blower inserted into an opening through the top cover 205.

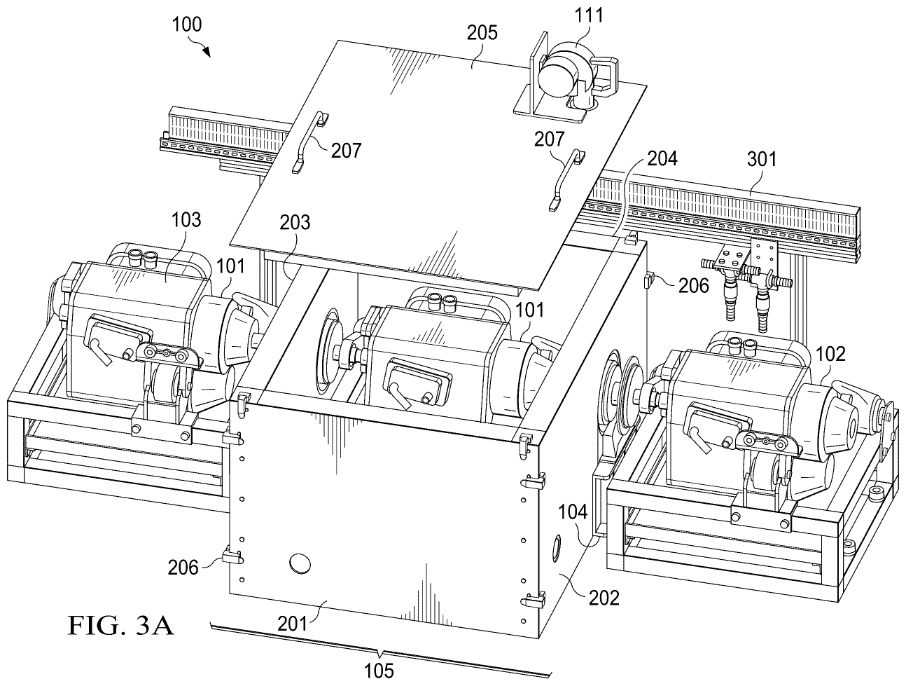

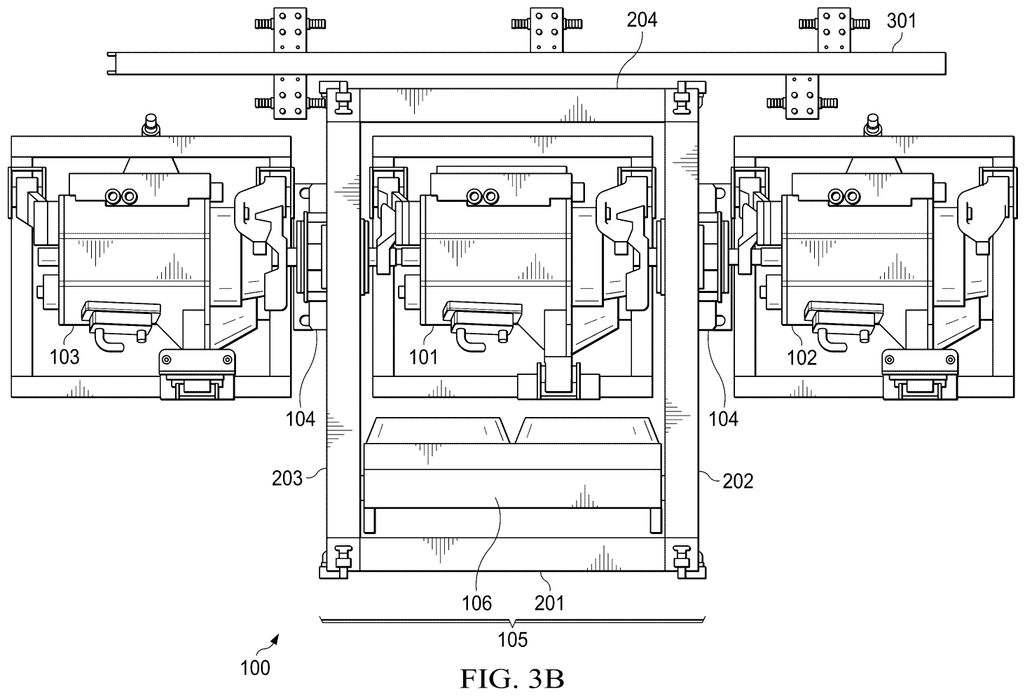

FIGS. 3A and 3B are pictorial illustrations of portions of the example thermal testing system 100 of FIG. 1 (excluding chiller 109 and coolant hoses 110, for simplicity and clarity). FIG. 3A is a perspective view, while FIG. 3B is a plan view. The RLU 107 and the LLU 108 are each mounted on open-sided three-dimensional rectangular frames designed to be easily moved by a forklift. The DUT 102 is likewise supported by a similar open-sided three-dimensional rectangular frame. The enclosure for the thermal chamber 105 is formed by the front cover 201, the right cover 202, the left cover 203, the rear cover 204, and the top cover 205. The front cover 201 supports the radiator and cooling fans 103. A tool/instrument rack 301 may be secured to the enclosure for the thermal chamber 105.

When assembled, the thermal chamber 105 may have dimensions of about 48 inches square and 24 inches in height. That small volume is more efficiently heated and cooled than commercially contracted test facilities. Heating and cooling of the entire dynamometer is not necessary for thermal testing of a drive unit assembly design, so the small volume is sufficient for testing purposes. The case of assembly and disassembly of the thermal testing system described simplifies testing of drive unit assembly designs. The test team is able to test the drive unit assembly at varying temperatures without the need to coordinate with external test suppliers, at costs that are a fraction of the amount charged by external test facilities while producing highly accurate test data and results. Test temperature can be controlled by the chiller, which is responsible for cooling or heating the coolant that is then passed through a radiator system located inside the thermal chamber and connected to a set of fans. Once the radiator reaches the desired temperature (due to coolant flow therethrough), the fans transfer the temperature from the radiator to the surrounding environment. The chamber walls and cover contain foam packing material to reduce air gap and losses to the external environment. The tight packaging of the chamber allows the drive unit to be cooled to the required temperature within a brief period with minimal losses. The thermal chamber is instrumented with thermocouples (temperature sensors) at various locations to ensure the entire chamber is at the desired temperature, and that no leaks or air gaps are present. Once the drive unit assembly is at the desired temperature, testing may be started. The thermal testing system is dynamic and can be utilized for various drive unit designs.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A structure for thermal testing of a drive unit assembly, the structure comprising:
four side panels and a top cover configured to be assembled around the drive unit assembly to form, with a surface underlying the drive unit assembly, a thermal chamber enclosing the drive unit assembly;
an opening through at least one of the four side panels positioned to allow mechanical connection therethrough of the drive unit assembly to at least one load unit outside the thermal chamber;
a plurality of latches configured to secure contacting pairs of the four side panels to each other and to secure the top cover to the four side panels; and
pass throughs within one or more of the four side panels for coolant hoses connecting thermal devices within the thermal chamber to a chiller outside the thermal chamber.

2. The structure according to claim 1, further comprising:
a radiator and cooling fans mounted within the thermal chamber, oriented to blow cool air on the drive unit assembly,
wherein the coolant hoses are configured to connect the radiator to the chiller.

3. The structure according to claim 1, wherein the opening comprises:
a first opening through a first one of the four side panels, the first opening positioned to allow mechanical connection therethrough of the drive unit assembly to a first load unit outside the thermal chamber; and
a second opening through a second one of the four side panels, the second opening positioned to allow mechanical connection therethrough of the drive unit assembly to a second load unit outside the thermal chamber.

4. The structure according to claim 1, wherein the at least one of the four side panels includes a cut-out and an insert collectively forming the opening.

5. The structure according to claim 1, further comprising:
a mount on one of the four side panels or the top cover, the mount configured to support a hot air blower; and
an opening through the top cover into which an outlet for the hot air blower is inserted.

6. The structure according to claim 1, wherein a mount for a torque meter is secured to at least one of the four side panels.

7. The structure according to claim 1, wherein each the four side panels comprises insulation material and metal on each side of the insulation material.

8. A method for thermal testing of a drive unit assembly, the method comprising:
assembling four side panels and a top cover around the drive unit assembly to form, with a surface underlying the drive unit assembly, a thermal chamber enclosing the drive unit assembly;
enclosing an opening through at least one of the four side panels for a mechanical connection between the drive unit assembly and at least one load unit outside the thermal chamber;
securing contacting pairs of the four side panels to each other and to secure the top cover to the four side panels with a plurality of latches; and
connecting thermal devices within the thermal chamber to a chiller outside the thermal chamber using coolant hoses received by pass throughs within one or more of the four side panels.

9. The method according to claim 8, further comprising:
mounting a radiator and cooling fans within the thermal chamber, oriented to blow cool air on the drive unit assembly; and
connecting the radiator to the chiller with the coolant hoses.

10. The method according to claim 8, wherein the opening comprises:
a first opening through a first one of the four side panels, the first opening positioned to allow mechanical connection therethrough of the drive unit assembly to a first load unit outside the thermal chamber; and
a second opening through a second one of the four side panels, the second opening positioned to allow mechanical connection therethrough of the drive unit assembly to a second load unit outside the thermal chamber.

11. The method according to claim 8, wherein the at least one of the four side panels includes a cut-out and an insert collectively forming the opening.

12. The method according to claim 8, further comprising:
supporting a hot air blower with a mount on one of the four side panels or the top cover; and
inserting an outlet for the hot air blower in an opening through the top cover.

13. The method according to claim 8, wherein a mount for a torque meter is secured to at least one of the four side panels.

14. The method according to claim 8, wherein each the four side panels comprises insulation material and metal on each side of the insulation material.
